(19) United States
(12) Patent Application Publication
(10) Pub. No.: US 2013/0291435 A1
(43) Pub. Date: Nov. 7, 2013

(54) DOUBLE-WALLED PLANTER WITH WATER RESERVOIR AND WATER LEVEL GAUGE

(71) Applicant: Beverly Ann Gettig, Hattiesburg, MS (US)

(72) Inventor: Beverly Ann Gettig, Hattiesburg, MS (US)

(21) Appl. No.: 13/572,584

(22) Filed: Aug. 10, 2012

Related U.S. Application Data
(60) Provisional application No. 61/643,469, filed on May 7, 2012.

(51) Int. Cl. A01G 27/02; A01G 9/02

(52) U.S. Cl. 47/79

(57) ABSTRACT

A planter prevents over-watering of plants that results in messy overflow of water. The planter allows plants to absorb water from the roots to promote healthier plants and prevent rot, such as rot of the trunk, stalk, and/or stem of a plant. The planter can have a double-wall that provides a self-contained chamber for water to be absorbed as needed from the roots up through small filtered holes in the bottom of the interior wall. A decorative cap or plug located on the top edge of the planter allows access to the chamber between the two walls of the planter. The planter includes a vertical transparent window along the exterior surface to allow for measurement of the water level inside the planter.

### CROSS-REFERENCE TO RELATED APPLICATION

This application claims the benefit of priority of U.S. provisional application number 61/643,469, filed May 7, 2012, the contents of which are herein incorporated by reference.

### BACKGROUND OF THE INVENTION

The present invention relates to planters and, more particularly, to a double-walled planter with a water reservoir and a water level gauge.

In many conventional planters, messy water overflow can ruin floors and carpets. When watering from the top of a planter, the soil may not absorb the water fast enough to prevent the water from running over the edge of the planter. Some planters have trays underneath, to allow water to pool, however, it can be easy to put too much water onto the soil such that it runs through the soil, into the tray, and overflows the tray.

As can be seen, there is a need for an improved planter that has a water reservoir and a water level gauge to prevent overfilling the water reservoir beyond its capacity.

### SUMMARY OF THE INVENTION

In one aspect of the present invention, a planter comprises an inner wall forming an inside of the planter adapted to hold planting media; an outer wall disposed about the inner wall; a water reservoir formed between the inner wall and the outer wall; a fill spout providing access to the water reservoir; and a water gauge disposed on the outer wall, the water gauge allowing a user to see a water level of water disposed in the water reservoir.

In another aspect of the present invention, a planter comprises an inner wall forming an inside of the planter adapted to hold planting media; an outer wall disposed about the inner wall; a water reservoir formed between the inner wall and the outer wall; a fill spout providing access to the water reservoir; a transparent water gauge disposed in the outer wall, the water gauge allowing a user to see a water level of water disposed in the water reservoir; a plug operable to cover the fill spout; and one or more holes on a bottom portion of the inner wall, the holes allowing water from the water reservoir to be absorbed in the planting media.

These and other features, aspects and advantages of the present invention will become better understood with reference to the following drawings, description and claims.

### BRIEF DESCRIPTION OF THE DRAWINGS

FIG. 1 is a perspective view of a planter, containing a plant, according to an exemplary embodiment of the present invention;

FIG. 2 is a perspective view of the planter of FIG. 1, with the plant removed; and

FIG. 3 is a cross-sectional view taken along line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a planter that prevents over-watering of plants that results in messy overflow of water. The planter allows plants to absorb water from the roots to promote healthier plants and prevent rot, such as rot of the trunk, stalk, and/or stem of a plant. The planter can have a double-wall that provides a self-contained chamber for water to be absorbed as needed from the roots up through small filtered holes in the bottom of the interior wall. A decorative cap or plug located on the top edge of the planter allows access to the chamber between the two walls of the planter. The planter includes a vertical transparent window along the exterior surface to allow for measurement of the water level inside the planter.

The planter of the present invention can eliminate the need to water plants directly onto the plant and/or soil, which can eliminate overflow due to the soil not instantly absorbing the water and runoff caused by pouring water onto a bushy plant with stems and leaves overhanging the edge of the planter. The planter of the present invention can also prevent planter tray overflow, as is common with convention planters with trays disposed thereunder.

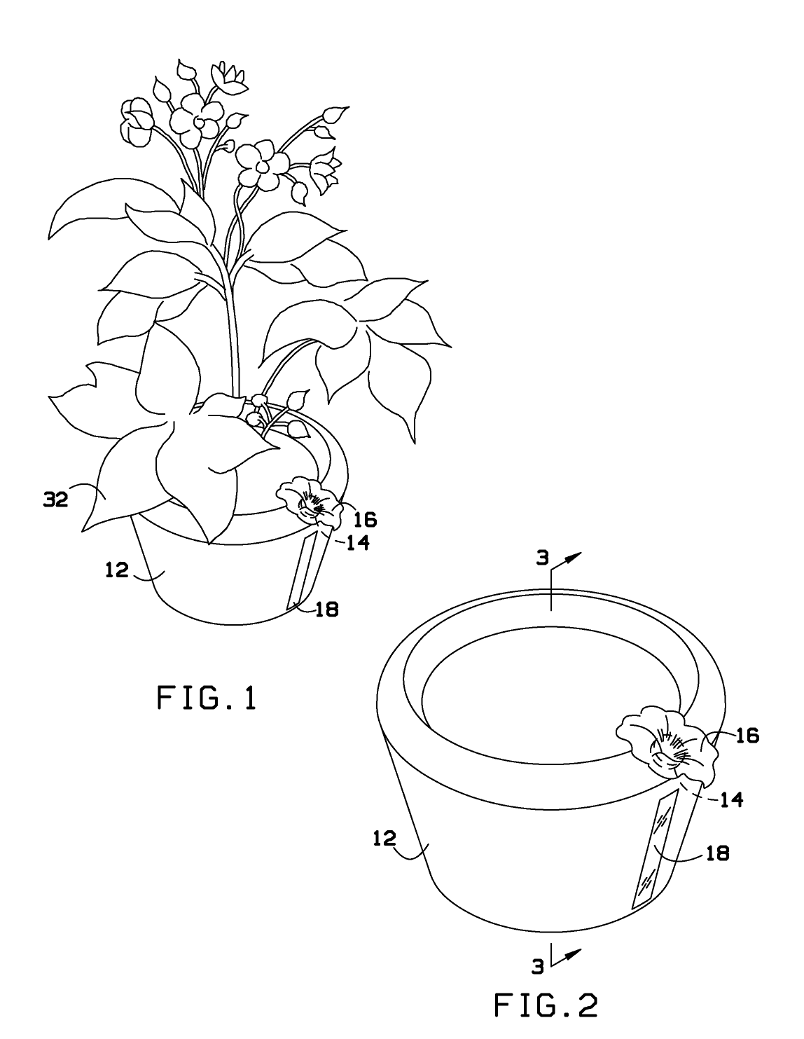

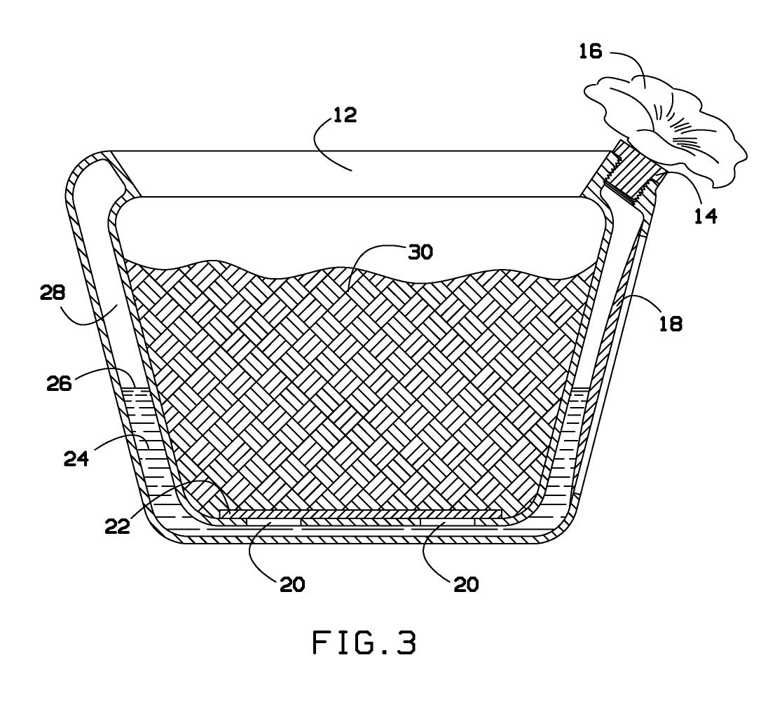

Referring now to FIGS. 1 through 3, a planter 12 includes an inner wall 36 adapted to hold planting media, such as soil 30. The planter 12 further includes an outer wall 34 disposed about the inner wall 36 to form a water reservoir 28 therebetween. The water reservoir 28 can hold water 24 that may be fed into the water reservoir 28 via a fill spout 38. The water reservoir 28 can have a width from about ½ inch to about 12 inches, depending on the size of the planter 12. The planter 12 can have various top diameters from about 4 inches to about 6 feet, for example. The height of the planter 12 can also vary from about 6 inches to about 6 feet, depending on application.

The fill spout 38 can be sealed with a removable water fill plug 14 to keep water 24 from spilling out of the fill spout 38. A decoration 16, such as a flower, can be disposed on the water fill plug 14. The water fill plug 14 can be made of various materials, typically rubber, plastic, or the like, and can be sized to fit into the fill spout 38.

Water through holes 20 can be disposed in the bottom of the inner wall 36 to allow water to flow into the soil 30 to feed a plant 32 disposed in the soil 30. A soil filter 22 can be disposed over the water through holes 20 to prevent soil from entering the water reservoir 28. The number, size and shape of the water through holes 20 can vary, depending on the size of the planter, its application, and the like. For example, from one to five water through holes 20 can be disposed in the bottom of the inner wall 36 of the planter 12. Each through hole 20 can be, for example, from about 1/16 inch to about six inches in diameter.

A transparent water gauge 18 can be disposed in a portion of the outer wall 34 of the planter 12. The transparent water gauge 18 can be used to see the level 26 of the water 24 in the water reservoir 28. The water gauge 18 can be made of various materials, such as plexi-glass, glass, plastic or the like. The water gauge 18 can run from near the bottom of the planter 12, such as about one to three inches from the bottom of the planter 12, generally vertically to near the top of the planter 12, typically about one to six inches from the top of the planter 12.

The planter 12 can be made from various materials, such as ceramic, clay, plastic, metal, glass, resin, composite, or the like. The planter 12 can be made in various shapes and sizes, such as round, square, or the like.

During use, the planter 12 may be filled with potting soil 30 and a plant 32 may be planted in the soil 30. The plug 14 can be removed and, while observing the water gauge 18, water 24 can be added to the water reservoir 28 until an appropriate level of water 24 is reached. Once the soil 30 has absorbed the water 24, and the water level drops to an appropriate threshold, such as when the water level can no longer be seen on the water gauge 18, more water can be added through the fill spout 38.

It should be understood, of course, that the foregoing relates to exemplary embodiments of the invention and that modifications may be made without departing from the spirit and scope of the invention as set forth in the following claims.

What is claimed is:

1. A planter comprising:
an inner wall forming an inside of the planter adapted to hold planting media;
an outer wall disposed about the inner wall;
a water reservoir formed between the inner wall and the outer wall;
a fill spout providing access to the water reservoir; and
a water gauge disposed on the outer wall, the water gauge allowing a user to see a water level of water disposed in the water reservoir.

2. The planter of claim 1, further comprising a plug operable to cover the fill spout.

3. The planter of claim 2, further comprising a decoration disposed on the plug.

4. The planter of claim 1, further comprising one or more holes on a bottom portion of the inner wall, the holes allowing water from the water reservoir to be absorbed in the planting media.

5. The planter of claim 4, further comprising a soil filter covering the holes.

6. The planter of claim 1, wherein the water gauge is a transparent water gauge running vertically in the outer wall.

7. A planter comprising:
an inner wall forming an inside of the planter adapted to hold planting media;
an outer wall disposed about the inner wall;
a water reservoir formed between the inner wall and the outer wall;
a fill spout providing access to the water reservoir;
a transparent water gauge disposed in the outer wall, the water gauge allowing a user to see a water level of water disposed in the water reservoir;
a plug operable to cover the fill spout; and
one or more holes on a bottom portion of the inner wall, the holes allowing water from the water reservoir to be absorbed in the planting media.

8. The planter of claim 7, further comprising a decoration disposed on the plug.

9. The planter of claim 7, further comprising a soil filter covering the holes.
